(19) United States
(12) Patent Application Publication
(10) Pub. No.: US 2017/0148100 A1
(43) Pub. Date: May 25, 2017

(54) SYSTEMS AND METHODS FOR MULTI-FACETED PERSONAL SECURITY

(71) Applicant: Seed My Future Association, Inc., Coral Gables, FL (US)

(72) Inventor: Jerome J. Schwartz, Coral Gables, FL (US)

(73) Assignee: Seed My Future Association, Inc., Coral Gables, FL (US)

(21) Appl. No.: 14/951,154

(22) Filed: Nov. 24, 2015

(51) Int. Cl. G06Q 40/08; G06Q 50/18

(52) U.S. Cl. CPC G06Q 40/08; G06Q 50/186

(57) ABSTRACT

Aspects of the present invention relate to the management and administration of an association for providing services to a plurality of members. Some aspects relate to calculation of a death benefit and a cash value amount. Some aspects relate to selection of optional services and service levels.

### BACKGROUND OF THE INVENTION

1. Field of the Invention

The present invention relates to methods for an organization to provide multiple benefits and services that increase many facets of a user's personal security.

2. Background and Related Art

Currently, a consumer may shop individually for a variety of services and benefits that enhance the consumer's sense of well-being, security and peace of mind. However, it is often difficult and time consuming to identify, research and acquire a multitude of benefits without spending a great deal of time and resources.

Additionally, governmental or industry regulations may preclude the direct acquisition of some benefits or combinations of benefits and services without expensive intermediaries.

### BRIEF SUMMARY OF THE INVENTION

A method and system are provided for managing and operating an organization that provides services and benefits to its membership, wherein these services and benefits relate to member well-being, security and independence. In some embodiments, members may purchase directly from a life insurance company a life insurance policy having a death benefit and a cash value amount. A guaranteed interest rate is paid on the cash value. A rapid underwriting review system in provided to determine the eligibility of the applicant to qualify for life insurance. Other services may be offered by the association or through the association, such as identify theft/protection notification or remediation, prescription discounts, pet insurance, a virtual document vault, legal service plans and contribution to charities.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows an exemplary general-purpose computer system;

FIG. 2 shows a representative networked system configuration related to embodiments of the present invention;

FIG. 3 shows a flow chart of an exemplary embodiment of the present invention comprising a rapid underwriting verification process;

FIG. 4 shows a flow chart of an exemplary embodiment of the present invention comprising calculation of a periodic life insurance premium;

FIG. 5 shows a flow chart of an exemplary embodiment of the present invention comprising prompting for selection of services and service levels;

FIG. 6 shows a flow chart of an exemplary embodiment of the present invention comprising an identity verification process; and

FIG. 7 shows a flow chart of an exemplary embodiment of the present invention comprising connecting a member directly with a life insurance company.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims. The principal financial goals of the target individuals are to educate their children and retire. In today's world, the chief impediment to reaching these goals is premature death, legal problems, identity theft, medical issues, etc. The target individuals recognize that it is unlikely social security and/or retirement plan benefits will appreciable assist them, if at all, in reaching their financial goals. The target individuals also realize that investing in the stock market, even over a substantial period of time, does not ensure that defined financial needs will be met.

The solution for these financial needs calls for a package of benefits that are low cost and can be marketed over the internet without intermediaries. The savings vehicle should be simple to understand and implement, have tax efficiencies, be flexible in the defined contribution chosen by the participant, be controlled by them, with portability and access to their money at any time.

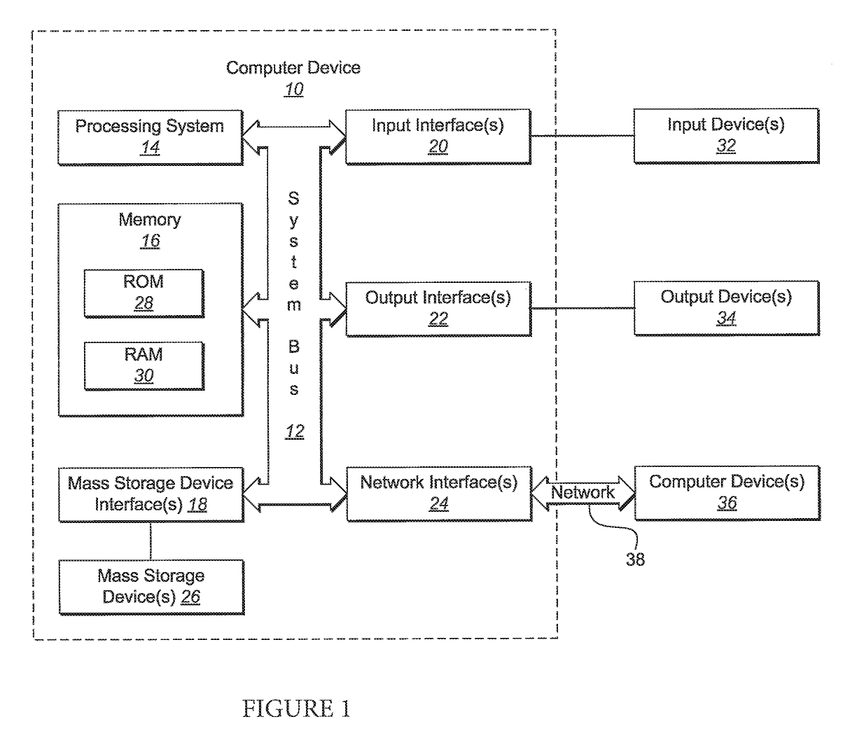

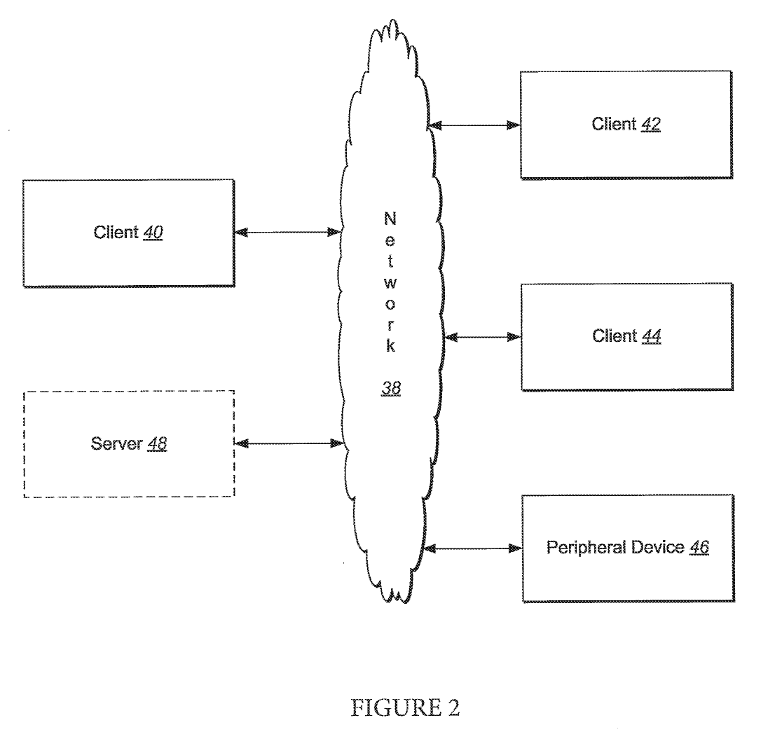

FIGS. 1 and 2 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard, touchpad, dedicated buttons, mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces may include a video adapter or an audio adapter or a parallel port.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

To minimize the need to download and/or install programs on users' computing devices, embodiments of the invention utilize existing web browser technology. Many browser programs currently exist or are under development, and it would be impossible to name all such browser programs, but examples of such programs include Microsoft's Internet Explorer, Mozilla Firefox, Google Chrome, Apple Safari, Opera Software's Opera browser, as well as myriad browsers specifically configured for specific devices, such as Internet-connected smart phones and the like. The exact display of each browser can vary from browser to browser and most are moderately to highly configurable so as to vary the exact display,

Many currently-available browser programs permit the installation of additional features, such as through what are commonly known as “browser extensions.” Browser extensions are becoming more and more common in today's browser programs, and have become one of if not the standard for extending the functionality of the browser programs. For browsers that do not currently support browser extensions, other mechanisms and installed programs are often available to provide similar functionality.

Embodiments of the invention may utilize a browser extension or similar format to provide functions in accordance with embodiments of the invention. The use and installation of a browser extension is typically significantly less involved and less computer-intensive than the use and installation of a stand-alone program. In many instances, the installation of the browser extension occurs essentially without the computer's operating system being made aware of any additional installation. Instead, the browser program itself handles the browser extension and any demands made by the browser extension.

### ASSOCIATION EMBODIMENTS

The Association eases the purchase of a life insurance policy. An additional benefit is the “safe” in which a Member can “store” important documents (driver's license, passport, medical information, legal documents, etc.) simply by taking a picture of them and uploading to their secure “safe.”

Additionally, the Association's systems integrate with all the benefit provider systems making it simple for the Member to access and manage the other benefits.

The Association's focus is to create a “package” of important benefits that are needed for self-reliance, and a method to self-manage them, for life.

In some embodiments of the present invention, an Association comprising a plurality of members may be organized. The Association may be formed for the purpose of providing services and benefits to the members. An administrative fee is paid by the member to an administrator or administrative entity for management of the Association in return for the basic benefits that come with membership or for the enhanced benefits for which the member has chosen to pay extra.

In some embodiments, multiple services may be provided to the members and different levels of service may be selected for each service and/or benefit rendered to a particular member. Each member receives a plurality of services and an opportunity to upgrade for an additional fee to a plurality of additional levels of service.

In some embodiments, an Association administrator may charge a periodic administrative fee for administration costs and additional periodic service fees for the services provided at the selected levels of service. The fees may vary depending on the quantity of services and the levels of service selected by the member.

In an exemplary embodiment of the present invention, an Association may provide identity protection to its members. Identity protection may comprise credit monitoring, fraud detection, activity verification and notification services as well as other related services. In some embodiments, a selectable level of service may further comprise identity restoration. Identity restoration may comprise financial, criminal, medical and governmental identity theft restoration. Some levels of identity restoration may comprise a dedicated case manager for restoring a member's identity to pre-theft status. These services may relieve the member/victim of administrative burdens while accelerating the investigation process for a swift resolution.

Some embodiments of the present invention may comprise member legal services. These embodiments may comprise nationwide, statewide or other discounted legal services. These legal services may comprise access to a network of attorneys who have contracted to provide members with free and/or discounted legal care. In some embodiments, various deductible limits, maximum fee or hourly limits and other limitations may be offered as specific levels of service.

Some embodiments of the present invention may comprise prescription discount services. These embodiments may offer members free or discounted prescription or health care services for the member and/or member's family. These embodiments may provide free or discounted health care products and/or services comprising prescription drugs, over-the-counter drugs, vision care, dental care and other benefits. In some embodiments, various deductible limits, maximum fee or hourly limits and other limitations may be offered as specific levels of service.

Some embodiments of the present invention may comprise pet insurance. These embodiments may comprise free or discounted pet care comprising an annual veterinary wellness exam, comprehensive injury coverage, illness coverage and other services and benefits. In some embodiments, various deductible limits, maximum fee or hourly limits and other limitations may be offered as specific levels of service. In some embodiments, member and beneficiary services may be provided through existing service networks who have negotiated with the organization administration.

Some embodiments of the present invention may comprise enhanced purchasing benefits. These benefits may comprise cash-back and discount offer management. Members may benefit from detection and management of discounts and savings during in-store and online purchases. When savings are available, members may receive the refund in their organization account or they may be redistributed to friends, family, charities or other designated recipients.

Some embodiments of the present invention comprise access to a digital document safe for secure storage of digital files. These embodiments allow association members to access secure cloud storage services with enhanced security for storage of their digital data.

Embodiments of the present invention comprise a death benefit. This benefit may be paid to designated beneficiaries in the event of a member's death. The death benefit amount is predetermined and is paid by the life insurance company. In some embodiments, the Association may provide direct access to a life insurance company and a member may pay fees directly to the life insurance company. In these embodiments, this direct access obviates the need for a broker and the associated brokerage fees thereby providing the life insurance company with a substantial savings. In some embodiments, the periodic fee for life insurance benefits may vary depending on the member's age, health, coverage amount and other factors. The insurance policy also has a cash value from which savings may be withdrawn and/or borrowed from.

Some embodiments of the present invention comprise services for donation to charitable organizations. In some embodiments, the association may withdraw a selected donation amount from a member's account on a periodic basis and donate that amount to a designated charity or charities.

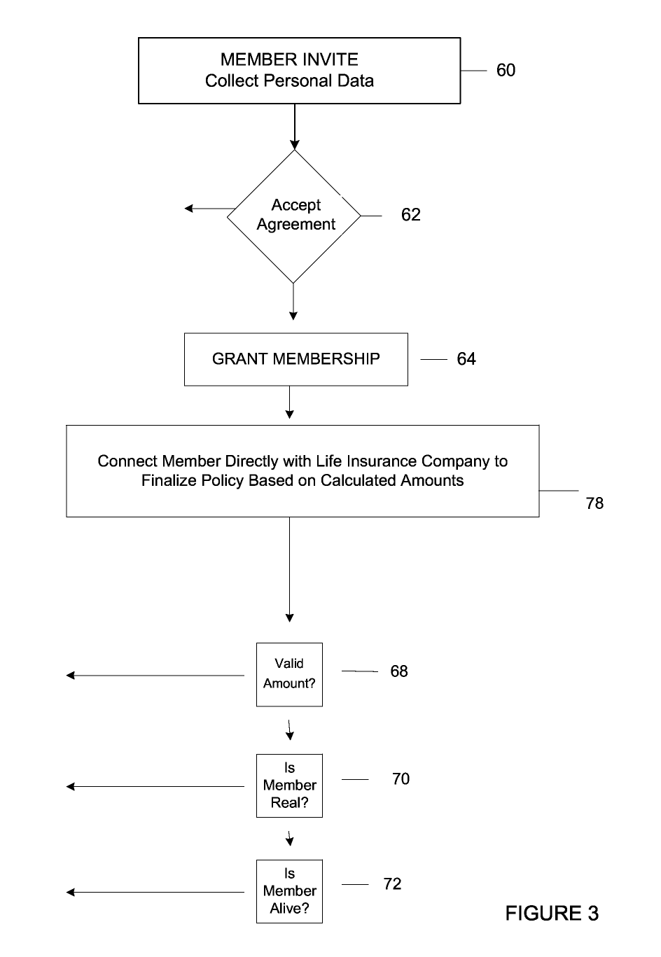

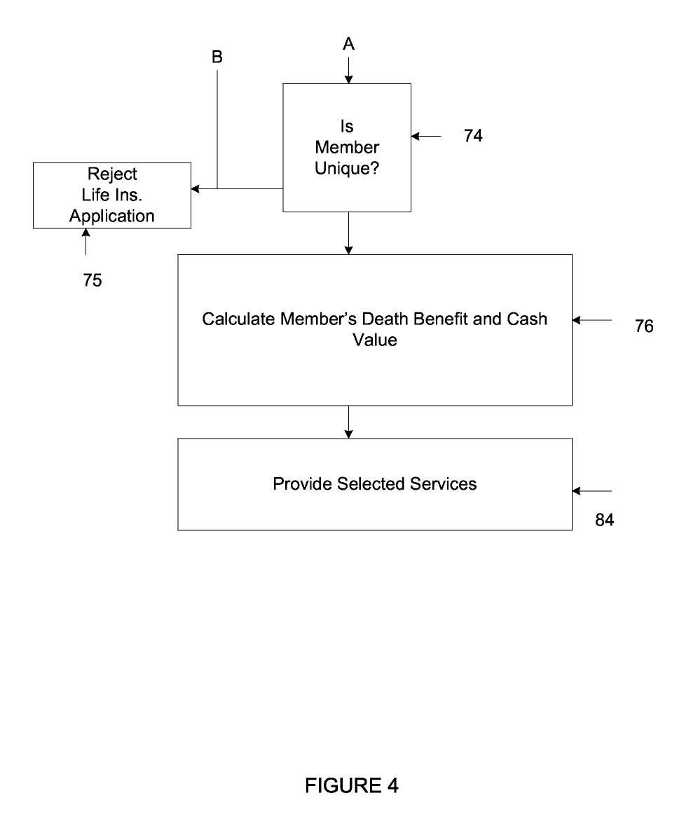

Some exemplary embodiments of the present invention may be described with reference to FIGS. 3 and 4. In these embodiments, an association membership and account management application or website may be used to prompt potential members or members for information and to receive member data and selections. This application or website may be accessed with a general purpose or dedicated purpose computing device as described above.

In an exemplary embodiment, a potential member may be invited 60 to join an Association. This process may comprise prompts and descriptive pages describing basic membership benefits and services and the basic membership fee. A potential member may accept a membership agreement 62 which may comprise a membership fee agreement. Acceptance of this agreement may result in a grant of membership 64 and the associated basic-level benefits.

In some embodiments, a member may be prompted on the Association page or an Insurance Company page or otherwise asked 66 to participate in a life insurance and savings plan. This prompt may comprise asking the member to commit to a life insurance fixed periodic payment amount above the membership and fee amount. A process for validating a member's identity will then begin. This verification may be performed using a three-step process comprising: verifying that the member is real 70, verifying that the member is alive 72 and verifying that the member has a unique identity 74. This may be performed by automated access to online databases and resources or by a third party underwriter.

If the member passes the verification process 70, 72, 74, member personal data may be accessed 76 or inquiries 78 made by the life insurance provider to determine if the applicant is eligible for life insurance. Based on the member identity verification and member personal data, a member will be asked directly by the life insurance provider to determine their planned participation level. If the member wishes to deposit $200 per month, a death benefit 76 (fixed), and a cash value amount (at a point in time) may be calculated. The user earns in one embodiment 2% guaranteed interest on the accumulated cash value amount. An additional 1% is called the current credited rate which is a declared rate and is not guaranteed and may vary, but serves as an incentive to sign up. A yet further 1% is paid as a commitment bonus. The commitment bonus is paid to those who regularly and consistently pay their month premiums.

If the death benefit is acceptable, the user enters into a contract directly with the life insurance company. A member death benefit 76 will be paid to a beneficiary upon the member's death.

The current process of underwriting, issuing and servicing life insurance products is cumbersome, time consuming and expensive, significantly reducing the product value proposition to the consumer. The Association simplifies that system to a level that has not been implemented heretofore. For example, the underwriting of the policy takes only 10-15 seconds via the use of a predictive analytical system that assigns a score based on information about the applicant generated from public information such as a centralized previous medical history (MIB); pharmaceutical drug use historical and current; previous and/or current legal issues; motor vehicle history; and other data. If the score is below a certain point level the applicant is declined for the saving benefit, if above they are immediately approved for the insurance coverage and the policy is immediately issued to a secure “safe”, from which they can manage their policy on-line, 24/7/365 from any device from anyplace in the world. For example, they can change their address, driver's license number, bank account from which the premium payments come directly to the insurance company, the premium payment itself, make a loan or withdrawal from their account value and even make a claim.

This direct connection bypasses a typical broker or other intermediary and their associated commission thereby providing a savings to the life insurance company so they can offer better benefits to the user.

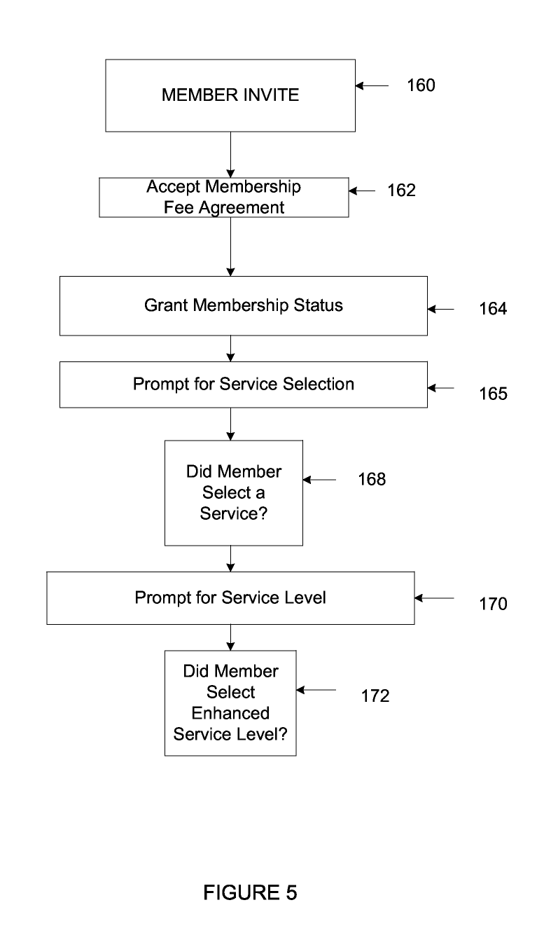

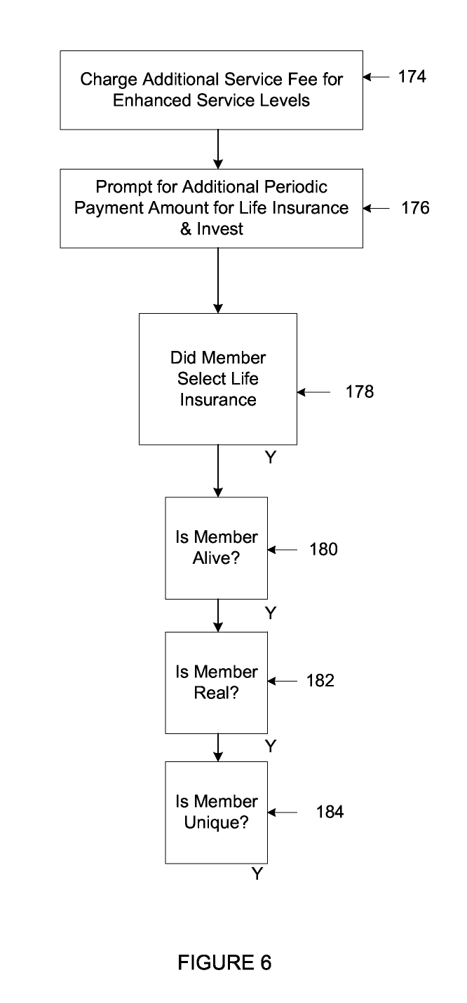

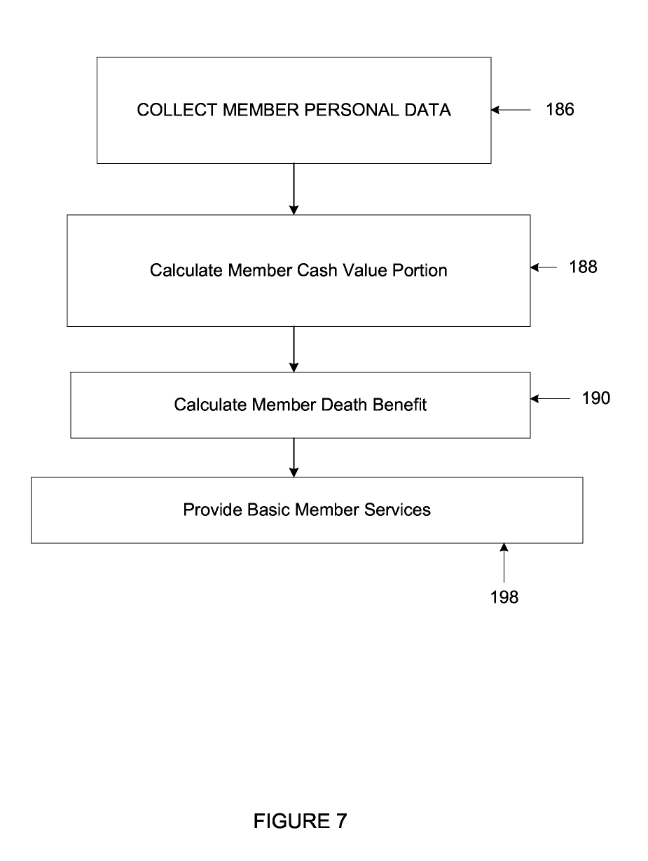

Some exemplary embodiments of the present invention may be described with reference to FIGS. 5-7. In these embodiments, an Association membership and account management application or website may be used to prompt potential members or members for information and to receive member data and selections. This application or website may be accessed with a general purpose or dedicated purpose computing device as described above.

In an exemplary embodiment, a potential member may be invited 160 to join an association. This process may comprise prompts and descriptive pages describing basic membership benefits and services and the basic membership fee. A potential member may accept a membership agreement 162 which may comprise a membership fee agreement. Acceptance of this agreement may result in a grant of membership 164 and the associated basic-level benefits.

In these exemplary embodiments, a member may then be prompted 166 to select additional services and benefits. A member may then be prompted 170 to select various levels of service, which may comprise coverage levels, deductible amounts, maximum benefit amounts and other degrees of service and benefit. If a member selects additional services 168 or enhanced benefit or service levels 172, additional charges may be applied to the member's account or periodic payment obligation 174.

In some embodiments, a member may be prompted or otherwise asked 176 to participate in a life insurance savings plan. This prompt may comprise asking the member to commit to a life insurance fixed periodic payment amount above the membership and enhanced service level fee amounts. If a member selects the life insurance option 178, the member is switched to a page managed by a life insurance company which may quickly underwrite a policy by using information prompted from the member to quickly verify the member's identity. This may be performed by accessing online databases and resources or by other means such as utilizing information provided on the Association Membership Application. In some embodiments, a third party predictive analytic partner goes out and gets the information. They may use the pharmaceutical information, drug information. The Association Membership Application such as their name, their address, social security number and accessing department of motor vehicle and the records and get the driver's license of the individual

After discerning the amount the member wishes to save, the member is then asked to provide HIPAA authorization and medical affirmation. A list of maladies is presented and the member clicks at the bottom of the page that they have never had any of the maladies. A predictive analytic system then applies points to each piece of information gathered. If the sum is above a baseline the member is accepted. This is called accept or decline simplified issue underwriting. The member is asked if they want to designate a beneficiary or to designate a secondary addressee. An application is then prefilled using the information provided and the application is digitally signed by the member. This can be done by clicking twice in boxes at the bottom of the application.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for providing services to members an Association, said method comprising:
prompting a potential member to select a periodic payment amount;
directly connecting said members to a life insurance company;
verifying the identity and qualification of a member using a predictive analytical underwriting system;
determining a death benefit amount;
determining a cash value to be used as a savings account based on said selected periodic payment amount; and
wherein said connecting allows for initiation of a life insurance policy paying a guaranteed interest rate on a cash value of an insurance policy.

2. The method of claim 1 further comprising paying said death benefit to a designated beneficiary of said member upon the death of said member.

3. The method of claim 1 further comprising:
providing a loan to said member from the cash value of the insurance policy.

4. The method of claim 1 further comprising:
prompting said member to select an optional service;
prompting said member to select a level of service corresponding to said optional service selection;
receiving a level of service selection;
withdrawing fees from said at least one member's periodic payment amount in exchange for said selected optional service performed at said selected level of service; and
providing said selected optional service at said selected level of service to said at least one member.

5. The method of claim 4, wherein said optional service is identity theft protection.

6. The method of claim 4, wherein said optional service is pet insurance.

7. The method of claim 4, wherein said optional service is a discount prescription service.

8. The method of claim 4, wherein said optional service is a legal services discount plan.

9. A method for providing services to members of an association, said method comprising:
prompting at least one of said members to select a level of service;
prompting said at least one of said members to select a periodic payment amount;
verifying that said at least one of said members is alive;
verifying that said at least one of said members is a legitimate person;
verifying that said at least one of said members is a unique person;
authorizing a death benefit via direct access to a life insurance company if the results of said verifying is positive;
determining a death benefit amount and a death benefit periodic premium based on said selected periodic payment amount;
paying said death benefit periodic premium to said life insurance company from said periodic payment amount of said at least one member;
withdrawing an administrative fee from said periodic payment amount of said at least one of said members.

10. A tangible, non-transitory, computer-readable medium comprising instructions instructing a processor in organization administration system to:
prompt at least one of said members to select a periodic payment amount;
verify that said at least one of said members is alive by a life verification process;
verify that said at least one of said members is a legitimate person by an identity legitimacy process;
verify that said at least one of said members is a unique person by a duplicate identity detection process;
determine a death benefit amount and a life insurance periodic premium based on said selected periodic payment amount;
directly connect said at least one of said members to a life insurance company if said life verification process, said identity legitimacy process and said duplicate identity detection processes yield positive results, wherein said connecting allows for initiation of a life insurance policy; and
invest a portion of said periodic payment amount to acquire interest on said portion for said at least one member.

11. The medium of claim 10 further comprising instructions for paying said death benefit to a beneficiary of said at least one member upon the death of said at least one member.

12. The medium of claim 10 further comprising instructions for guaranteeing a minimum interest on the accumulated cash value of the insurance policy.

13. The medium of claim 10 further comprising instructions for:
withdrawing said death benefit periodic premium amount from said periodic payment amount of said at least one member; and
paying said death benefit periodic premium to said life insurance company.

14. The medium of claim 10 further comprising instructions for:
prompting said at least one member to select an optional service;
receiving an optional service selection;
prompting said at least one member to select a level of service corresponding to said optional service selection;
receiving a level of service selection;
withdrawing fees from said at least one member's periodic payment amount in exchange for said selected optional service performed at said selected level of service; and
providing said selected optional service at said selected level of service to said at least one member.

15. The medium of claim 10 wherein said optional service is identity theft protection.

16. The medium of claim 10 wherein said optional service is pet insurance.

17. The medium of claim 10 wherein said optional service is a discount prescription service.
